(19) United States
(12) Patent Application Publication
(10) Pub. No.: US 2009/0290743 A1
(43) Pub. Date: Nov. 26, 2009

(54) SKIN-MOUNTED DIGITAL DEVICE WITH STACKED FLEX CIRCUIT

(76) Inventor: David W. Carroll, Grantsburg, WI (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/400,691

(22) Filed: Mar. 9, 2009

Related U.S. Application Data
(60) Provisional application No. 61/034,820, filed on Mar. 7, 2008.

(51) Int. Cl. H04R 1/00

(52) U.S. Cl. 381/385

(57) ABSTRACT

A skin-mounted digital audio device composed of one or more removable adhesive sheets, a battery layer, and flex circuitry. The device can be folded and unfolded, and permits convenient, hands-free wearing and operation by a user via the adhesive sheet(s).

### CROSS-REFERENCE TO RELATED APPLICATIONS

This application claims priority under 35 U.S.C. §119(e)(1) to U.S. Provisional Patent Application Ser. No. 61/034,820, filed Mar. 7, 2008, entitled “Skin-Mounted Digital Device With Stacked Flex Circuit” and bearing Attorney Docket No. T589.107.101; the entire teachings of which are incorporated herein by reference.

### BACKGROUND

The digital audio and communication device market provides a growing number of size and shape options for mobile activities. Many are used handheld and stored in the pocket, belt pouch or purse. Some are worn on the head by being hung from or clipped to the ear, while others are worn over or behind the head. Device use varies but generally involves these applications: music player, radio, cell phone, image capture and showing, e-mail, location finding, Internet viewing, and data storage and retrieval. Many formats use wired ear bud speakers. Most devices are able to work with secondary wireless devices permitting relaying of audio for hands-free use. A few include sufficient processing power and software application for limited speech recognition to control applications. New formats described, for example, in U.S. application Ser. No. 12/098,247, filed Apr. 4, 2008 and entitled “Mobile Personal Audio Device”, the teachings of which are incorporated herein by reference, deliver audio directly from a single wearable digital device, wire free, using tubes.

Various user needs are not fully met by currently-available digital audio and communication device designs, formats and user device options. Examples of unsatisfied current mobile device users are police, package delivery persons, plumbers, electricians, doctors, heavy equipment operators, military and food service personnel. Each of these currently use cell phones but have difficulty with their use during a workday. Issues include: high mobility during tasks preventing frequent use and reducing productivity; required use of hands for other tasks while communicating; demand for speedier and more intermittent communication; reluctance to use multiple device solutions due to battery charging and technical set up issues; retention, bumping and poor esthetics for ear mounted devices; lack of sanitation due to device handling; lack of all day comfort; and difficulty hearing and being heard in some environments due to poor audio positioning; set up time to deal with tangled wires for hands-free ear bud use; and arm fatigue while holding a handset device during extended conversations.

To meet these needs, a simpler design and format would be beneficial, especially for hands-free centric audio-based users. For example a device needs to remain in position for all day use but still be removable and pocketed when desired. It needs to move with the user but retain audio position. Advanced and soon to be available product components are making these mobile digital devices progressively smaller. One example of this was shown by LG at the CES show in January of 2008. Their wristwatch type format solution for some data and phone applications demonstrates an entire device in a newly reduced size. However, their solution requires the user to raise and hold to the side of the head a dedicated one hand/arm for device use. Music devices such as the Apple Shuffle™ and iPods™ all require them to be mounted on the body and wired to the ear. The size of the Shuffle™ is a good example of size improvements for audio only devices. These examples of size and weight advancement demonstrate the capability for devices of the present disclosure.

### SUMMARY

Some aspects of the present disclosure relate to a wearable audio device (e.g., a cell phone or cell phone wireless interface). In this regard, the smallest and lightest possible format for a cell phone device can be constructed using a flexible circuit, advanced low-power and compressed processing and wireless chip sets, light and efficient power supply and battery, a thin and light display, and offer the option of attaching the device to the skin for hands free use. One optional form of the device entails a folding feature permitting a user to fold the flexible circuit to provide a lightweight, simple to assemble, and durable form of the audio device.

Some device features in accordance with options of the present disclosure include:
Device can be held to the skin by an adhesive sheet to eliminate the heavier, less sleek and uncomfortable current form factor issues.
Layers can be individually coated for protection from moisture and friction.
Component layers can be nested and stacked to make the device as thin as possible.
Layers can be attached at the ends to permit a single layer to be folded into a complete device.
Low-voltage switch can use the wearer's skin as a conductor and work to automatically turn the device on/off or sleep/wake.
Flex circuit electronic board can be formed with extensions to properly position microphone and speaker in a durable package. Optionally, these extensions can be hinged to nest the extensions for pocketing.
Layers can be replaced using connectors and be replaceable.
Adhesive assembly sheets can be used to reduce waste, provide user repair and user updating.
Layers can be integrated within the flex circuit or into a hole in the flex circuit to fold for improved assembly, for example via a poly LiION flexible battery.
Layers can integrate a heat dissipation surface(s) that also act as part of or all of the case's surface.
Optionally the flexible form can be used without the adhesive attachment to the body by being held in place during use.
Layers can wrap to provide the device's case form.
Flexible circuit can have additional strengthening materials embedded therein to help hold the desired shape and protect the components and circuitry.
Flexible circuit can have areas of materials that can be backlit or lit to create a lighted area of the device.
Flex circuitry when folded can form to expose, thinly cover, or position a flex-mounted control switch.
Flex circuitry can be made to fold and attach with adhesives.
Flex circuitry can be made to be folded or laminated to create the device's footprint.
Flex circuitry layers, either folded or laminated, can be attached at a center point to permit individual flexing of each layer while remaining connected to each other for electronic connectivity.
Flex circuitry can expose to areas of the user's skin to verify skin contact for switching purposes. These features can be offset toward the skin to allow for the adhesive layer thickness.
Flex circuitry and other flexible layers of the device (e.g., flexible battery and flexible display) can be attached by adhesives in a fashion to retain a single human form factor shape. Such a shape can be selected to have a curve commensurate with the user's face and user's leg approximately horizontally in a pocket to be 3 inches radius.
Flex circuitry can be provided for a behind-the-head device configuration for providing stereo audio to both of a user's ears.
Flex circuitry can be configured to facilitate a behind-the-head format in providing stereo and microphone applications.
Flex circuitry can be configured to provide a behind-the-head format to provide stereo plus a conductive speaker audio output (optionally with microphone and related applications).
Flexible device can include only a conductive microphone and speaker with no other extensions to the mouth or ear of the user.

Devices of the present disclosure address many of the above-identified problems associated with currently-available digital communication devices. For example, the devices of the present disclosure are able to be quickly and accurately placed for optimal use of a speaker components at a user's ear and a microphone component at user's mouth. Some devices of the present disclosure are ready for hands-free operation at all times and are comfortable in that location over long periods of time.

Devices of the present disclosure also optionally address users that are unsatisfied with the bulky and technical look of current hands-free mobile offerings. Devices of the present disclosure provide a less visually obtrusive and more esthetically pleasing format.

In addition, audio devices of the present disclosure are more durable than current hard cased solutions. Device of the present disclosure are less likely to be dropped, and when dropped, the devices are more able to absorb shock while retaining operational capacity. Similarly, some of the audio devices of the present disclosure are more durable from wire fraying and shorting.

In other embodiments, devices of the present disclosure incorporate a backlight for user placed images for single image display. This effectively provides a lit advertisement or photo.

Devices of the present disclosure also contemplate, in some embodiments, using the stacked and/or folded group of layers of flexible and/or rigid-flex circuits in a nested fashion to efficiently overlay and create a thinner and more durable device. In particular shapes (see over ear, under ear and cheek formats described below) that provide durable extensions to the ear and mouth and provide shape memory to assure correct positioning of speaker and microphone.

The weight reduction and semi-flexibility of the devices of the present disclosure provide a new format for mobile users. This format is uniquely able to mount using adhesion to the skin.

One design format of some devices of the present disclosure positions a cell phone between the ear and the mouth thereby reducing the size of the device and locating audio in/out ideally.

Newly available and soon to be available thin and flexible products will make further advancements in weight and thinness for devices of the present disclosure. The present disclosure in its widest application form will use chip advancements akin to Intel's Atom™ processor to eventually provide advanced speech recognition processing power in this form. A full communication form of devices of the present disclosure uses micro processors, wireless chip or chip set with antenna, voice-based or combination switch and voice-based user interface and control, adhesive mounting methods, and microphone and speaker positioning methods. Aspects of the present disclosure can be also applied as a very simple manually replaceable image-only version of the skin-mounted laminated device.

### BRIEF DESCRIPTION OF THE DRAWINGS

FIG. 1A is a simplified plan view of a skin-mounted digital device in accordance with principles of the present disclosure and in an unfolded state;

FIG. 1B is a side view of the device of FIG. 1A in a folded state;

FIG. 1C is a simplified plan view of another digital device in accordance with principles of the present disclosure and in an unfolded state;

FIG. 1D is a side view of the device of FIG. 1C;

FIG. 1E is a side view of the device of FIG. 1C in a folded state;

FIG. 2A is a simplified perspective view of another digital device in accordance with principles of the present disclosure;

FIG. 2B is a side view of the device of FIG. 2A;

FIG. 3A is a perspective view of the device of FIG. 2A as worn and operated by a user;

FIG. 3B is a side view of another digital device in accordance with principles of the present disclosure as worn and operated by a user;

FIG. 4 is a perspective view of another digital device in accordance with principles of the present disclosure as worn and operated by a user;

FIG. 5A is a perspective view of another digital device in accordance with principles of the present disclosure as worn and operated by a user;

FIG. 5B is an enlarged side view of the device of FIG. 5A;

FIG. 6 is a perspective view of another digital device in accordance with principles of the present disclosure as worn and operated by a user;

FIG. 7 is a simplified perspective view of another digital device in accordance with principles of the present disclosure;

FIG. 8A is a rear view of another digital device in accordance with principles of the present disclosure as worn and operated by a user;

FIG. 8B is a side view the digital device of FIG. 8A as worn and operated by a user;

FIG. 9 is a perspective view of another digital device in accordance with principles of the present disclosure as worn and operated by a user;

FIG. 10 is an exploded, perspective view of another digital device in accordance with principles of the present disclosure;

FIG. 11 is a perspective view of the digital device of FIG. 10 as worn and operated by a user; and

FIG. 12 is an exploded, perspective view of another digital device in accordance with principles of the present disclosure.

### DETAILED DESCRIPTION

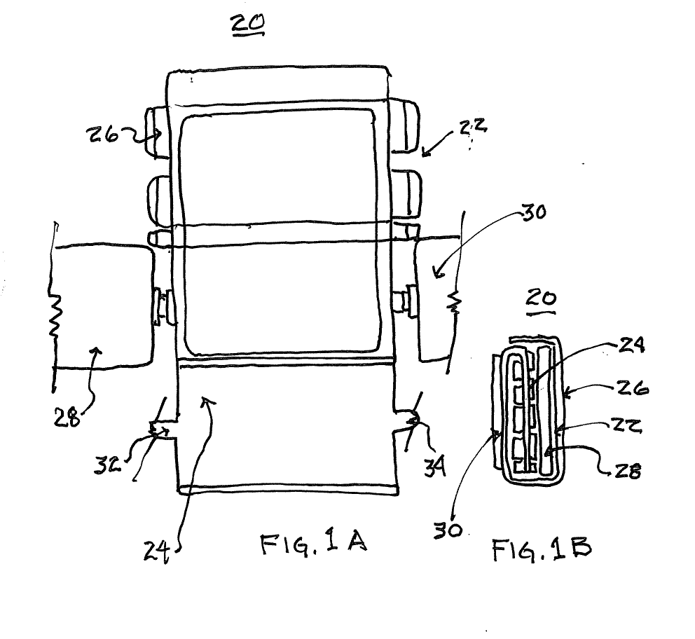

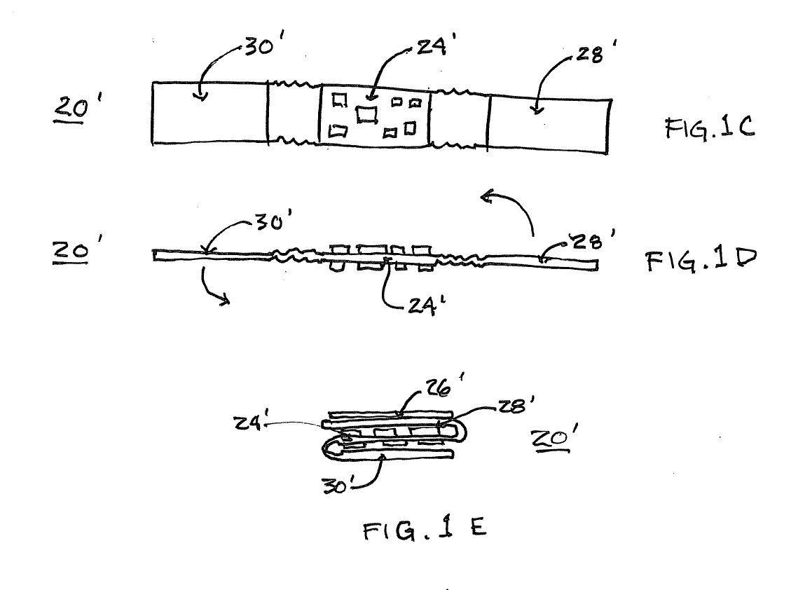

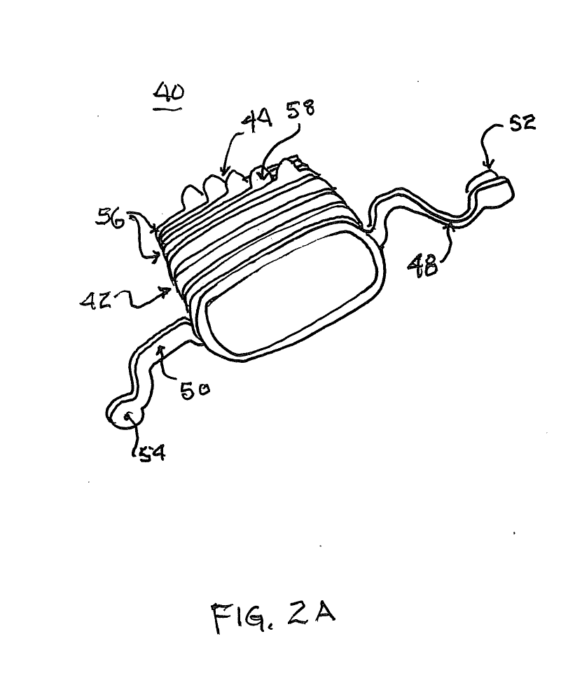

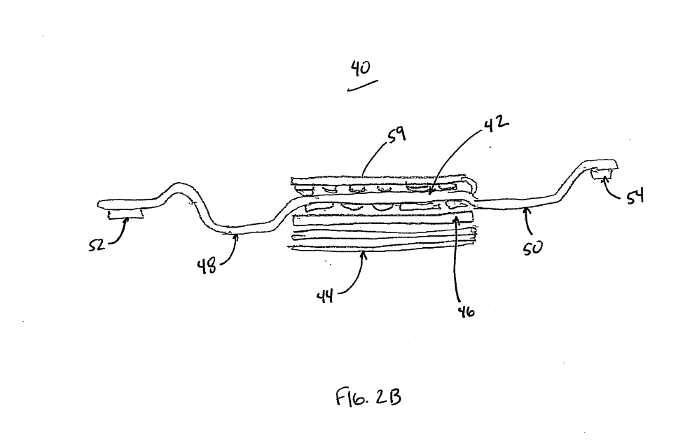

A skin-mounted digital device 20 in accordance with some aspects of the present disclosure is generally illustrated in FIGS. 1A and 1B. In general terms, the device 20 is configured to perform one or more of desired audio and/or visual operations (e.g., phone, personal computer, MP3, PDA, etc.), and includes a case 22 formed by or optionally encasing a flexible circuit board 24, an adhesive structure 26, and a power source 28. In some embodiments, the device 20 can include additional, optional components including one or more of a display 30, one or more speakers 32, and one or more microphones 34. In general terms, the flexible circuit board 24 is maintained by, and in some embodiments forms, the case 22. In this regard, one or more sections or layers of the flexible circuit board 24 are foldable relative to one another (as shown, for example in FIG. 1B), defining a small, streamlined shape when folded. The flexible circuit board 24 is powered by the power source 28. In some embodiments, the power source 28 is a battery, such as a poly LiION flexible battery. Further, the flexible circuit board 24 is electrically connected to the display 30, the speaker(s) 32 and/or the microphone(s) 34 depending upon the particular configuration of the device 20. In this regard, the flexible circuit board 24 is programmed to operate the devices 30-34 in performing one or more operational features provided by the device 20. In addition, the flexible circuit board 24 (and/or the case 22 when provided as a component apart from the flexible circuit board 24) can incorporate a heat dissipating material as an optional feature. Finally, the adhesive structure 26 is maintained by the flexible circuit board 24/case 22 and is configured for selective securement of the device 20 to a user's skin. In some embodiments, the adhesive structure 26 includes one or more adhesive sheets carrying or providing an appropriate adhesive surface (e.g., a pressure sensitive adhesive).

With the above general understanding of the device 20 in mind, the device 20 can assume a wide variety of formats appropriate for a selected end-use application. As described below, the device 20 can be configured to be “worn” at a user's head/cheek, at the user's wrist, etc. Regardless of the intended end-use application, the provision of the adhesive structure 26 facilitates convenient, long-term, hands-free wearing and use by the user, and can incorporate one or more of the optional display, speaker, and/or microphone components described above. For example, FIGS. 1C-1E illustrate an alternative arrangement of the device 20′ in an unfolded state (FIGS. 1C and 1D) and a folded state (FIG. 1E). The device 20′ is optionally configured to be applied or worn at a user's wrist, and includes the flex circuit board 24′, the power source 28′ and the display 30′ (or other light modifying structure or device). The power source 28′ and the display 30′ are foldably connected to the flex circuit board 24′ (indicated by arrows in FIG. 1D). In the folded state of FIG. 1E, then, the flex circuit board 24′ serves as a circuitry layer, and the power source 28′ and the display 30′ serves or form layers at opposite sides of the circuitry layer. The adhesive structure 26′ (referenced generally) optionally selectively secures the layers relative to one another, permitting sliding movement there between when the device 20′ is worn by a user and thus permitting desired user movement, and permits selective attachment of the device 20′ to the user's skin in a manner permitting establishment of a very low voltage electrical circuit through the user's skin.

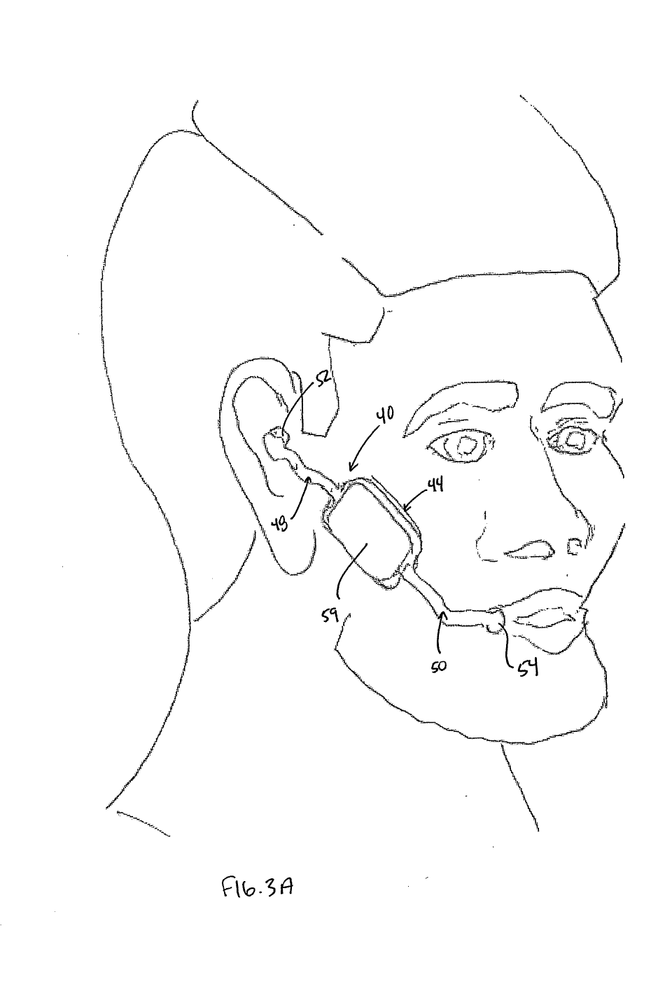

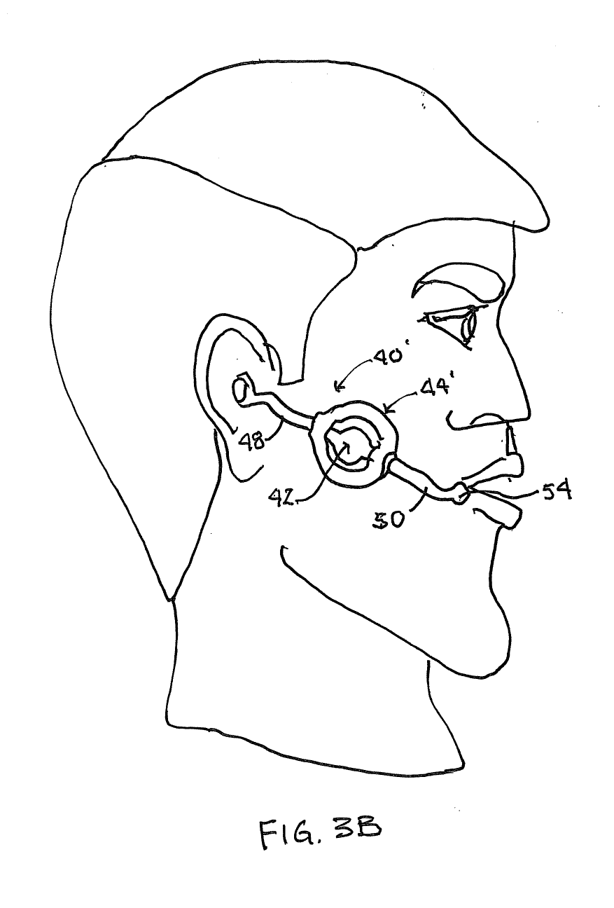

In some embodiments, the digital device of the present disclosure is programmed to operate as a cell phone and/or as a wireless cell phone interface. For example, FIGS. 2A and 2B illustrate a digital device 40 in accordance with aspects of the present disclosure and configured for cell phone-type applications. The device 40 includes a circuit board 42, such as a flexible circuit board or a flex/rigid circuit board, adapted or programmed to perform cell phone-type operations (e.g., the device 40 is operable as a cell phone or establishes a wireless connection/interface with a separate cell phone device). Additional components necessary for performing cell phone-type operations, as known in the art, are included with the digital device 40 but omitted from the views for ease of illustration. Regardless, the device 40 can have a skin-toned color and/or exterior texture akin to human skin.

The device 40 can be folded/unfolded in some embodiments. In the folded state reflected in FIGS. 2A and 2B, the circuit board 42 defines a case feature of the device 40. Alternatively, a separate case can be provided. Regardless, the device 40 further includes an adhesive structure 44, a power source (e.g., battery) 46, opposing stems 48, 50, one or more speakers 52, and one or more microphones 54. The first stem 48 carries the speaker(s) 52 (or optionally establishes an audio pathway between a speaker assembled within the circuit board 42), whereas the second stem 50 carries the microphone 54. The stems 48, 50 can be integrally formed by or with the flexible circuit 42 or can be separate components. As described in greater detail below, the stems 48, 50 facilitate desired positioning of the speaker(s) 52 and the microphone(s) 54 relative to a user when the device 40 is worn. In this regard, the adhesive structure 44 facilitates hands-free mounting of the device 42 to the user. As best shown in FIG. 2A, in some embodiments the adhesive structure 44 includes a stack of adhesive sheets 56, with each of the adhesive sheets or layers 56 including an optional pull tab 58 that promotes user removal of a “worn” outer-most adhesive sheet 56 (e.g., when the adhesiveness of the outer-most sheet 56 is reduced, a user can simply remove the outer-most sheet 56 thereby exposing the immediately underlying sheet 56 in “refreshing” an adhesiveness of the device 40).

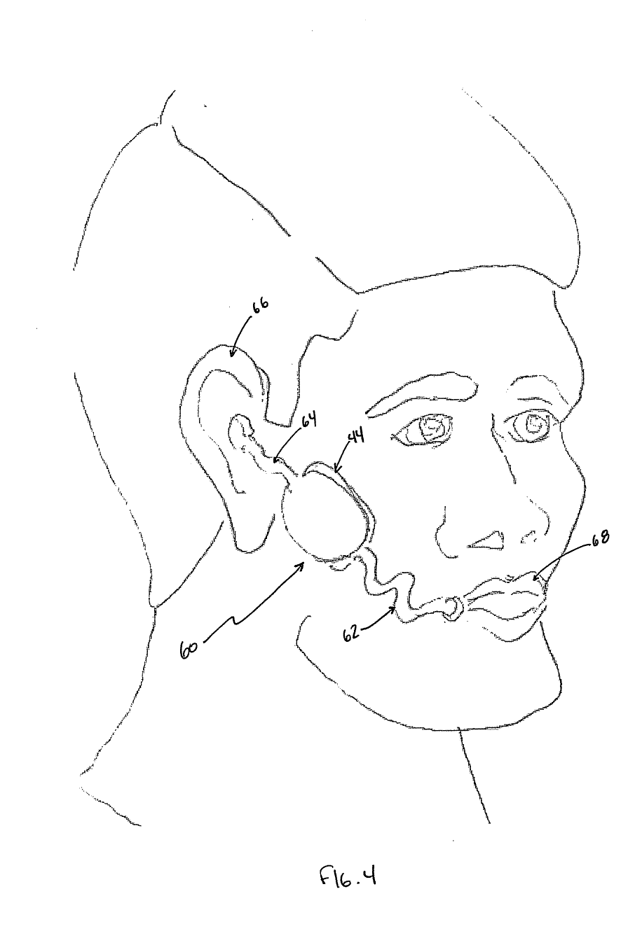

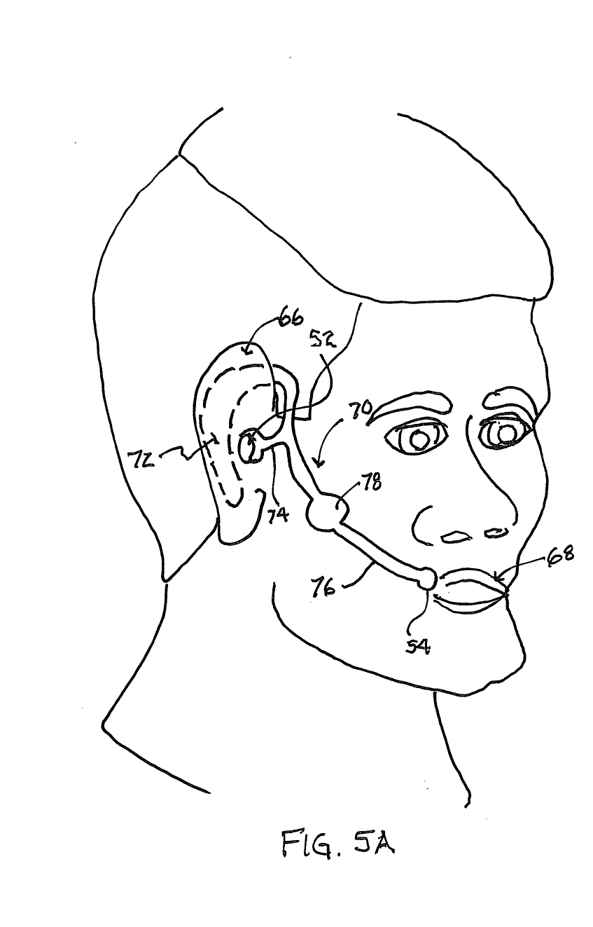

The above-described device 40 can be configured for wearing by a user in a variety of fashions. For example, FIG. 3A illustrates the device 40 as worn by a user. As shown, the adhesive structure 44 self-retains the device 40 onto the user's face (e.g., is applied to the user's cheek). In this manner, the speaker 52 is properly positioned within the user's ear, whereas the microphone 54 is placed in close proximity to the user's mouth. As shown, the flex circuitry 42 establishes the stems 48, 50 in promoting desired positioning of the speaker 52 and the microphone 54. In some embodiments, the device 40 can further include an optional display and/or touch screen 59. When worn by the user as shown in FIG. 3A, the display/screen 59 is readily viewable by persons other than the user.

A related embodiment digital device 40′ is shown in FIG. 3B, and again includes the flex circuitry 42, the first stem 48, and the second stem 50 as described above. Further, the device 40′ includes an adhesive structure 44′ for selective securing the flex circuitry 42 (and any other wireless components mounted thereto) to the user's face/cheek. With the embodiment of FIG. 3B, however, the adhesive structure 44′ has a ring-like shape (and can include a stack of individually removable ring-shaped adhesive sheets). The ring adhesive structure 44′ holds the flex circuitry 42 and the stems 48, 50 tightly and securely as the user moves and speaks, and ideally positions the microphone(s) 54 for noise-canceling and input for speech recognition.

An alternative embodiment digital device 60 is shown in FIG. 4 as being worn by a user. The device 60 is highly akin to the device 40 (FIGS. 2A and 2B) described above. In general terms, the device 60 incorporates the adhesive structure 44 described above for hands-free application to the user's face. Further, stems 62, 64 have a flexible configuration, thereby facilitating desired placement of the speaker(s) 52 and/or the microphone(s) 54 relative to the user's ear 66 and mouth 68.

The first stem 62 (and optionally the second stem 64) can incorporate various features that promote desired placement of the microphone(s) 54 relative to the user's mouth 68. As a point of reference, the distance between the user's ear and mouth will vary from person-to-person. The first stem 62 is optionally configured to permit a user to vary a length of extension, for example by forming the wave-like shape shown in FIG. 4. With this construction, the user can simply “pull” or “push” on the first stem 62 (e.g., at a location of the microphone(s) 54) relative to the adhesive structure 44 to bring the microphone(s) 54 in closer proximity to the user's mouth 68. An additional, optional adhesive structure (not shown) can be carried by the first stem 62 and placed into adhesive contact with the user's face to “lock” the first stem 62 in the desired extension length or position. As an alternative to the sinusoidal wave-type shape shown in FIG. 4, the first stem 62 can include other extendible formats, such as a spiral.

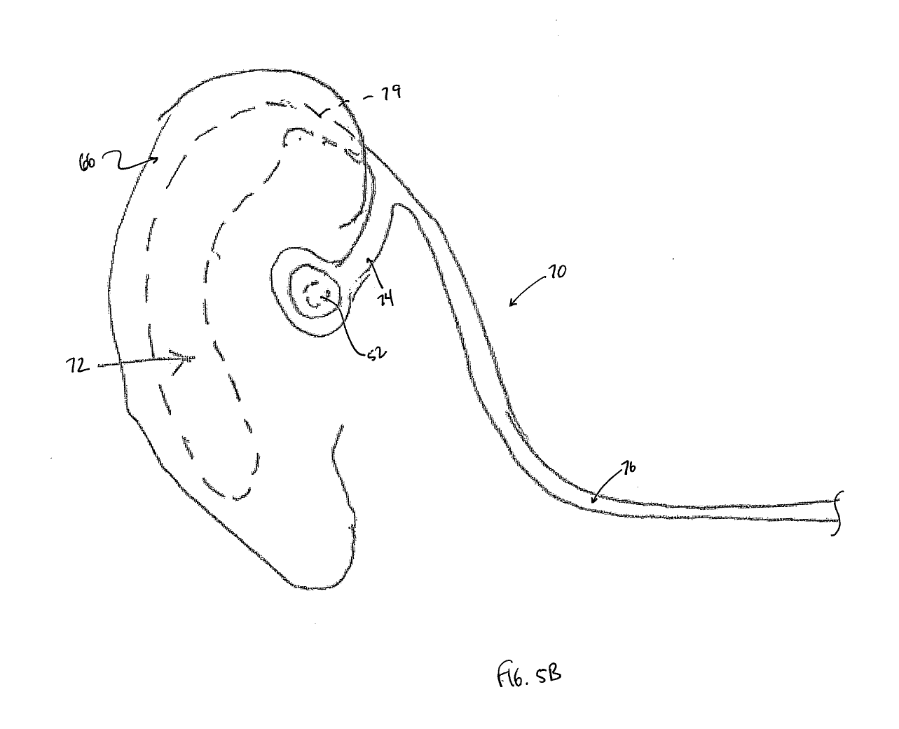

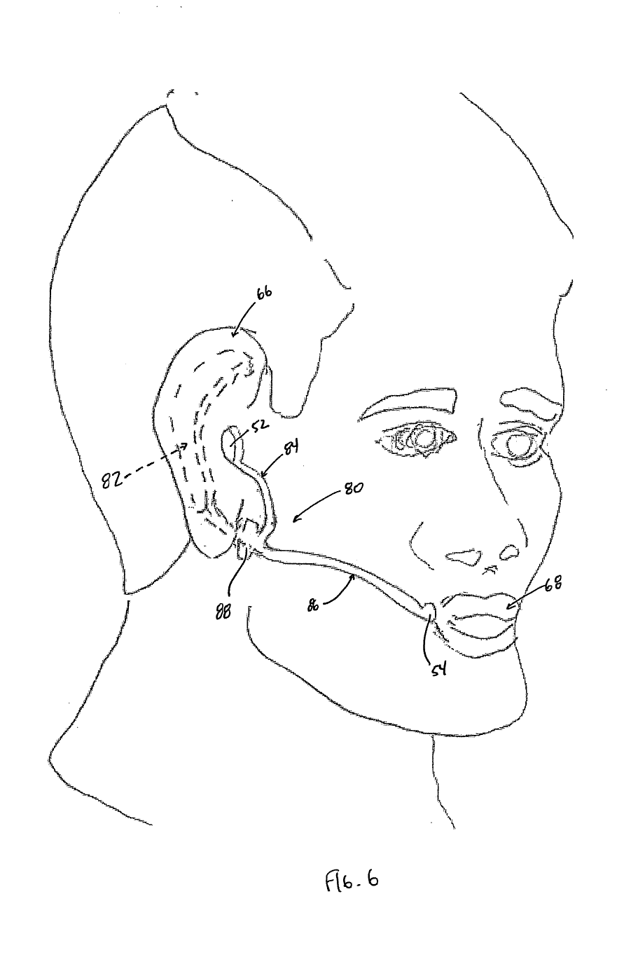

Another, similar embodiment digital device 70 is shown in FIG. 5A as worn by a user. The device 70 is highly akin to the device 40 (FIGS. 2A and 2B) described above. However, with the configuration of FIG. 5A, a flex circuit board 72 (referenced generally) is configured for placement behind the user's ear 66, with the stems 74, 76 extending therefrom in a manner facilitating placement over the user's ear 66 in desired positioning of the speaker(s) 52 and the microphone(s) 54 relative to the user's ear 66 and mouth 68. As shown, an optional adhesive structure 78 can further be provided (e.g., along the second stem 76) for better securement of the device 70 relative to the user's face. The second stem 76 can include the wave and/or spiral shapes described above to provide an extendible feature.

The device 70 is shown in greater detail in FIG. 5B that otherwise illustrates the flex circuit board 72 (and other wireless electronic circuitry or directly mounted components) secured behind the user's hear 66 with an adhesive structure 79 (referenced generally). The first stem 74 positions the speaker 52 into the user's ear 66, and can optionally incorporate a bending-type sensor (not shown); with this construction, when the first stem 74 is bent to position the speaker 52 into the user's ear 66, the sensor will send a corresponding signal to the circuitry that is otherwise programmed to recognize an “in use” operation as being implicated. Thus, a position of the first stem 74 can serve as an “on/off” type switch for the device 70. Alternatively or in addition, the second stem 76 can carry a sensor that detects an orientation (or change in orientation) of the second stem 76, with this signal also being useful in dictating on or off operation of the device 70. For example, the device 70 can be programmed to automatically turn off or on depending upon an orientation of the second stem 76, a change in the pulled or pressed condition of the second stem 76, etc.

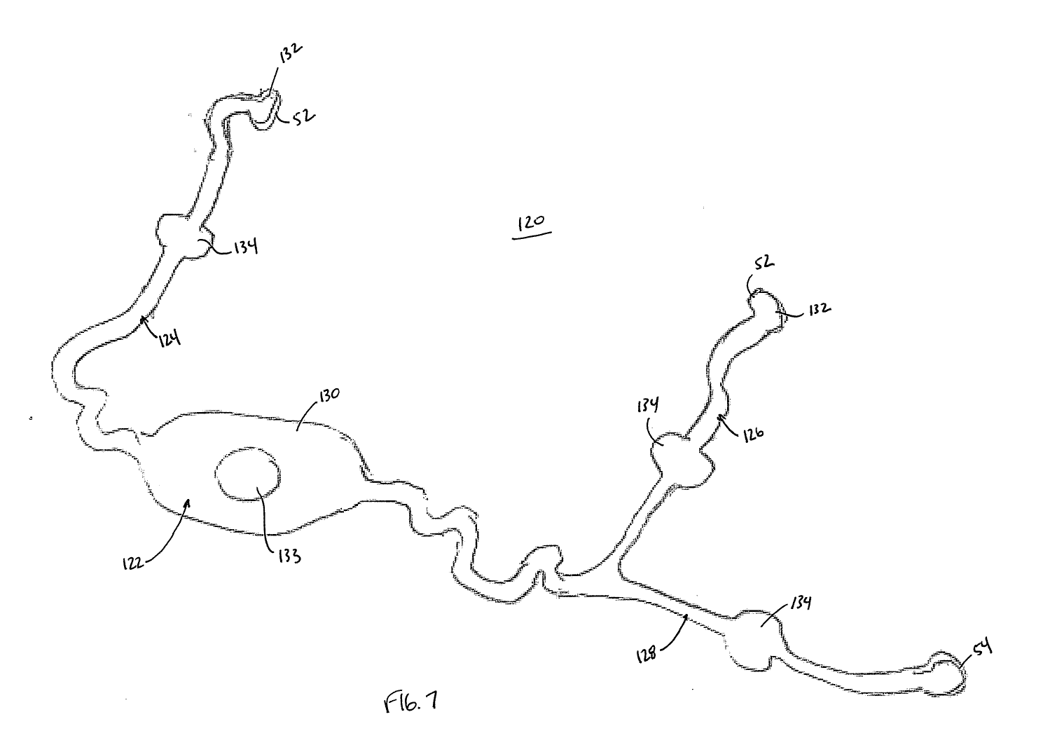

A related, alternative embodiment digital device 80 is shown in FIG. 6 as worn by a user. In generally terms, the device 80 is akin to the device 70 described above, except that during use, the device 80 is positioned to extend under the user's ear 66 (as opposed to over the user's ear 66 as with the device 70 of FIGS. 5A and 5B). As with previous embodiments, the device 80 includes a flexible circuit board (referenced generally) 82, along with stems 84, 86. With the construction of FIG. 6, the flexible circuit board 82 is adapted for placement behind the user's ear 66, with the stems 84, 86 adapted for extension from a point underneath the user's ear 66. An adhesive structure (not shown) as described above is provided and maintains the flex circuit board 82 (and any other direct mounted, wireless components) on the user's head. As with previous embodiments, the stems 84, 86 desirably position the speaker(s) 52 and the microphone(s) 54 relative to the user's ear 66 and mouth 68. Finally, the device 80 provides a hinge 88 (e.g, a flex circuit living hinge) at which the stems 84, 86 can pivot relative to the flexible circuit 82. Thus, the first stem 64 can be bent by the user to desirably position the speaker(s) 52 at/within the user's ear 66.

With each of the embodiments of FIGS. 3-6, folding/unfolding of one or both of the stems relative to the flex circuit board “base” can be sensed and employed to dictate an operational state of the device. For example, with respect to the device 80 of FIG. 6, the stems 84, 86 can be folded and unfolded relative to the flex circuit board 82. With this construction, the flex circuit board 82 can be programmed to operate in an “on” state when one or both of the stems 84 and/or 86 are unfolded, and in an “off” or “sleep” state when one or both of the stems 84 and/or 86 are folded. In this regard, the device 80 can further include a biasing device (e.g., spring-loaded tension) that biases the stems 84 and/or 86 to or toward the folded state.

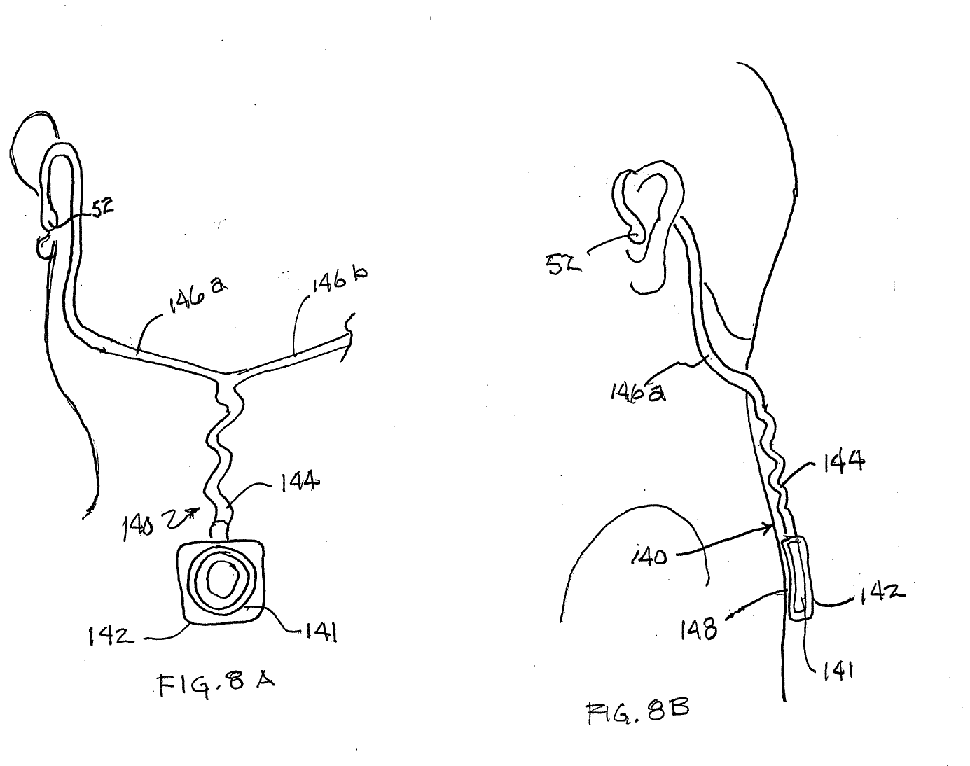

Yet another embodiment digital device 120 adapted for performing audio-type operations (e.g., cell phone, MP3 player, etc.), is shown in FIG. 7. As with previous embodiments, the device 120 includes a flexible or rigid/flex circuit board 122 along with two or more stems 124, 126, 128. With the configuration of FIG. 7, two of the stems 124, 126 promote placement of speakers 52 within both of the user's ears, whereas the third stem 128 promotes desired placement of the microphone 54 relative to the user's mouth. Alternatively, the speakers 52 can be located within a base 130 of the device 120, with the stems 124, 126 serving as conduits in delivering audio sounds to ear buds 132 carried by each of the stems 124, 126. In some embodiments, the device 120 further includes a conductive speaker 133 maintained by the base 130. Regardless, the device 120 is configured for placement behind a user's neck, with the stems 124, 126 extending around opposite sides of the user's neck. In some embodiments, an adhesive structure 134 is optionally provided along one or more of the stems 124-128 to facilitate desired placement relative to the user's face. In other embodiments, the adhesive structure 134 is located only along the stem 128 otherwise carrying the microphone(s) 54. In yet other embodiments, the adhesive structures 134 can be eliminated.

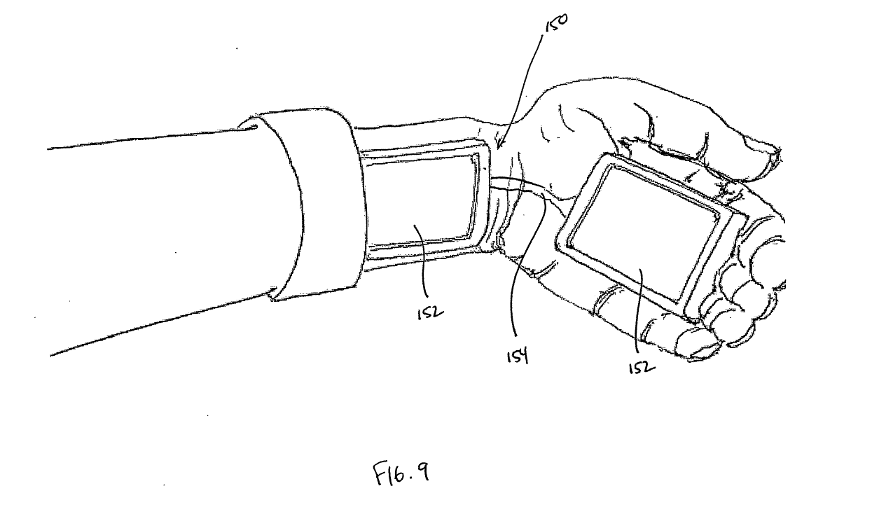

Yet another embodiment audio digital device 140 is shown in various states in FIGS. 8A and 8B. As with previous embodiments, the device 140 incorporates a flexible circuit and an optional adhesive structure for maintaining features of the device 140 along a back of a user's neck. For example, the device 140 can include an audio device 141, a housing 142, flex circuitry 144, stems 146a, 146b, and an adhesive structure 148. The audio device 141 can assume any form currently known or in the future developed (e.g., an MP3 player or iPod™), with the housing 142 sized to selectively receive and maintain the audio device 141 in a manner permitting convenient connection of the flex circuitry 144 to the audio device 141 (e.g., via an audio output jack provided with the audio device 141). The stems 146a, 146b are carried by the housing 142, and are configured for arranging speakers 52 carried thereby into the user's ears. Finally, the adhesive structure 148 can have any of the forms described above, and is carried by the housing 142. More particularly, the adhesive structure 148 provides an exposed (and optionally replaceable) layer of pressure sensitive adhesive by which the user can temporarily attach the housing 142 (and thus the audio device 141 attached thereto) to a location along the user's body that is otherwise behind the user's neck. The device 140 can be secured to the user's skin (e.g., under the user's clothes), or directly on to the user's clothes.

While the above-described embodiments have referenced devices incorporating audio features, in other embodiments, a display-only type format can be provided. For example, FIG. 9 illustrates an alternative embodiment digital device 150 incorporating a plurality of displays 152 carrying or interconnected by a flexible circuit 154. With this configuration, the displays 152 can be maintained relative to a user's hand and wrist via adhesive structures (not shown) for simple viewing by the user in a highly portable fashion. Thus, the device 150 is configured for selective attachment to the user's wrist.

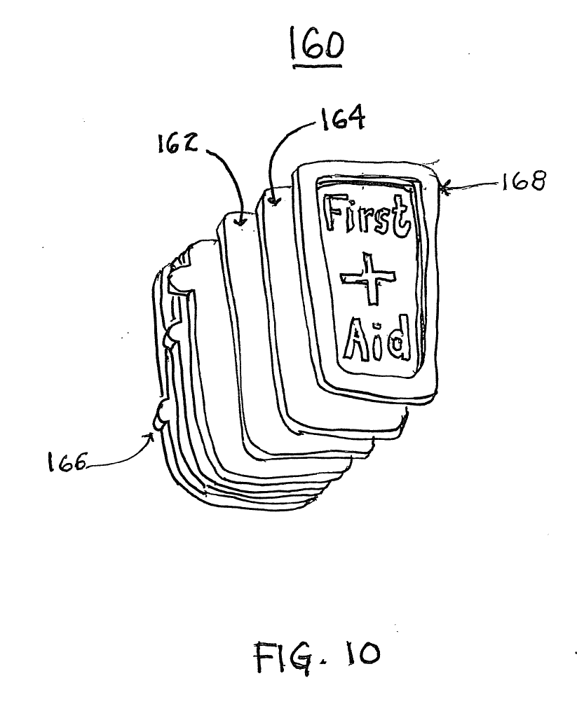

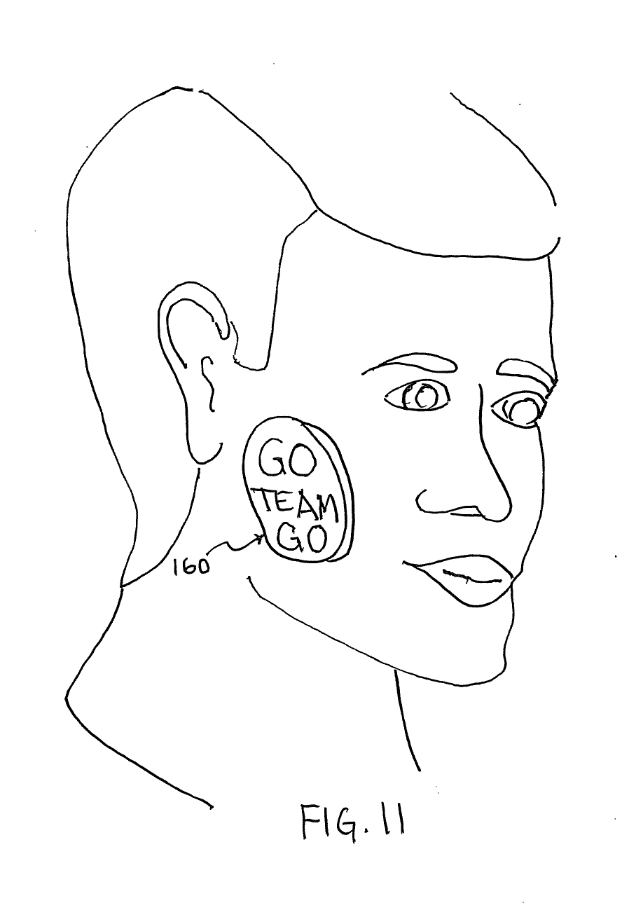

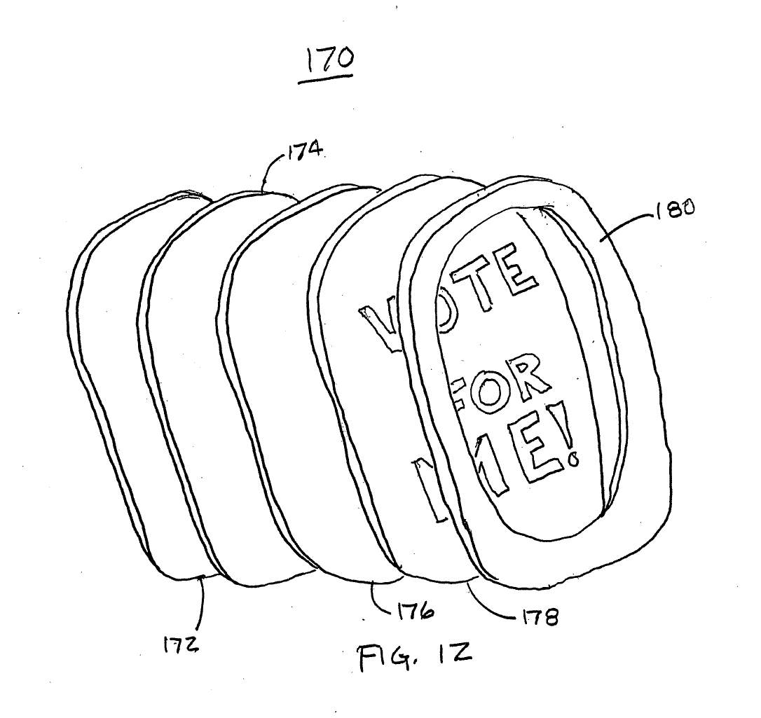

Yet another embodiment digital device 160 in accordance with aspects of the present disclosure is shown in FIG. 10. In general terms, the device 160 provides a unique-wearable display feature and includes a flexible power source 162 (e.g., a flexible LiION battery), a back-light 164 (e.g., a flexible OLED light) powered by the power source 162, and an adhesive structure 166 as described above. In addition, in some embodiments, the device 160 incorporates a frame 168 that is assembleable to the back-light 164 (or other component of the device 160), with the frame 168 maintaining a desired display. For example, with the one embodiment of FIG. 10, the frame 168 maintains a display relating to “First Aid”. A number of different displays can be incorporated with the device 160 as desired by the user. With this in mind, FIG. 11 illustrates the device 160 as worn by a user, with the device 160 presenting a different display format as compared to FIG. 10.

Another, related embodiment device 170 in accordance with aspects of the present disclosure is provided in FIG. 12. As with the configurations of FIGS. 10 and 11, the device 170 is configured for wearing on a user's face, and incorporates an adhesive structure 172 along with a flexible circuit 174. Further, the flexible circuit 174 is optionally configured to automatically switch on or off when placed in contact with the user's skin. In related embodiments, this same feature can be applied with any of the previous devices described herein, with the device automatically switching between sleep/active modes, on/off modes, etc., depending upon sensed contact with the user's skin. The device 170 can optionally further including a light and/or sound emitting layer 176 and an optional colored or patterned design later 178. Even further, an optional cover or coating layer 180 can be provided.

Although the present disclosure has been described with reference to preferred embodiments, workers skilled in the art will recognize that changes can be made in form and detail without departing from the spirit and scope of the present disclosure.

What is claimed is:

1. A skin-mounted digital audio device composed of one or more removable adhesive sheets, a battery layer, and a circuit board layer.

2. The device of claim 1, wherein said circuit board layer has two flexible circuit extensions, where one extension extends to the ear with a speaker mounted at the end of said ear extension and where a second extension extends to the mouth with a microphone mounted at the end of said mouth extension all layers.

3. The device of claim 1, wherein all composed layers are made of flexible materials.

4. The device of claim 1, wherein a bent shape is formed into the flexible circuit extensions to properly position the speaker and the microphone for proper use.

5. The device of claim 1, wherein the adhesive sheet is configured to conduct a very low voltage electrical current through a skin of user, device further being configured to be activated in response to the low voltage electrical current.

6. The device of claim 1, wherein the adhesive sheet is formed as a pocket for the device so the device may be removed and returned without removal of the adhesive holder.

7. The device of claim 1, further comprising one or more switches controlling an operational mode of the device.

8. The device of claim 1, wherein the circuit board contains components and antenna required for wireless operation applications.

9. The device of claim 1, further comprising a flesh colored and skin textured final layer.

10. The device of claim 1, further comprising a display layer.

11. The device of claim 2, further comprising a hinging means located adjoining a core of the device to automatically fold the flexible circuit extensions alongside the device.

12. A skin-mounted flexible circuit digital device composed of one or more removable adhesive layers, a battery layer, a light-emitting layer and a light modifying material layer.

13. The device of claim 12, wherein the adhesive layer permits limited and aligned parallel movement between layers positioned at opposite sides of the adhesive layer.

14. The device of claim 12, wherein all layers are mechanically connected with sliding devices to permit flexibility of a laminated format while retaining relative orientation to each other.

15. The device of claim 12, wherein the battery and light-emitting layers flex around the adhesive layers.

16. The device of claim 12, wherein device is configured to form a very low voltage electrical circuit through a skin of a wearer to complete a switch that activates the device.

17. A skin-mountable flexible circuit or rigid-flex digital device composed of a single flexible layer with micro processing, power management, memory, battery attachment, display or light emitting polymer attachment, wherein said single layer is foldable to encase the device.

18. The device of claim 17, wherein one of the folded layers provides user interface input means.

19. The device of claim 17, wherein the device is configured such that a user can access and replace at least one component, or grouping of components, or attachments and fold to reassemble the product.
